(19) United States
(12) Patent Application Publication
(10) Pub. No.: US 2020/0063401 A1
(43) Pub. Date: Feb. 27, 2020

(54) Terrain Feed Forward Calculation

(71) Applicant: Deere & Company, Moline, IL (US)

(72) Inventor: Lance R. Sherlock, Dubuque, IA (US)

(21) Appl. No.: 16/108,285

(22) Filed: Aug. 22, 2018

(51) Int. Cl. E02F 9/26; G05D 1/02

(52) U.S. Cl. CPC E02F 9/261; G05D 2201/0202; G05D 1/0219; G05D 1/0246

(57) ABSTRACT

A sensor-augmented guidance system and apparatus for optimizing the operating parameters of a work machine. The work machine comprising a sensor facing in a forward direction, and configured to collect image data in a field of view of the sensor. A sensor processing unit communicatively coupled with the sensor, the sensor processing unit configured to receive the image data from the sensor, and identify either upcoming terrain or an upcoming travel path based on the image data. A weight detector to the work machine to calculate a measured weight of the payload supported by the bin. A vehicle control unit communicatively coupled with the sensor processing unit and the weight detector, the vehicle control unit configured to modify an operating parameter of the work machine in response to a predictive load based on the measured weight, and at least one of the upcoming terrain and the upcoming travel path.

### CROSS-REFERENCE TO RELATED APPLICATIONS

N/A

### FIELD OF THE DISCLOSURE

The present disclosure relates to a system and apparatus for a sensor-augmented work machine.

### BACKGROUND

In the construction industry, various work machines, such as articulated dump trucks, may be utilized in the hauling of loads over rough terrain. In certain examples, the articulated dump truck includes a frame with a load bin pivotally coupled to the frame. The articulated dump truck generally traverses hills where when going uphill, the transmission often needs to downshift or the engine speed needs to increase to retain a consistent work machine speed. On downhills, an operator may improperly operate the work machine causing it to achieve too much speed, thereby causing excess wear and abuse of some drivetrain components, as well as fuel burning inefficiencies. Additionally, if an operator inappropriately attempts sharp turns with large payloads at high speeds, tipping may become an issue. The following selection of concepts addresses these issues.

### SUMMARY

This summary is provided to introduce a selection of concepts that are further described below in the detailed description and accompanying drawings. This summary is not intended to identify key or essential features of the appended claims, nor is it intended to be used as an aid in determining the scope of the appended claims.

The present disclosure includes a sensor-augmented guidance system and apparatus which allows for the optimization of the operating parameters of a work machine.

According to an aspect of the present disclosure, the work machine may comprise a front portion including a front frame, a front wheel assembly operably coupled to the front frame to support the front portion, a trailer portion including a rear frame and a bin supported by the rear frame where the bin is configured to support a payload. A first and second rear wheel assemblies may be operably coupled to the rear frame to support the trailer portion. A frame coupling may be positioned between the front frame and the rear frame, the frame coupling being configured to provide a pivoting movement between the front frame and the rear frame.

The sensor-augmented guidance system may comprise of a sensor coupled to the front frame of the work machine wherein the sensor faces a forward direction. The sensor may be configured to collect image data in a field of view of the sensor. The system may further comprise of a sensor processing unit communicatively coupled with the sensor wherein the sensor processing unit is configured to receive the image data from the sensor, and identify either an upcoming terrain or an upcoming travel path based on the image data. The system may further comprise a weight detector positioned to calculate a measured weight of the payload supported by the bin. The system may also comprise a vehicle control unit communicatively coupled with the sensor processing unit and the weight detector, wherein the vehicle control unit is configured to modify the operating parameter of the work machine in response to a predictive load based on the measured weight, and either the upcoming terrain or upcoming travel path.

The system may further comprise an inclination data sensor communicatively coupled to the vehicle control unit. The inclination data sensor may be configured to measure a real-time inclination of the work machine, wherein the vehicle control unit modifies the operating parameter of the work machine in response to the predictive load based on a predictive rate of change of the inclination. The predictive rate of change of the inclination may be calculated from a ground speed and a rate of change of a moving horizon from the image data. Alternatively, the predictive rate of change of the inclination may be based on a moving average of a real-time inclination over a measured distance.

The system may further comprise an attitude data sensor communicatively coupled to the vehicle control unit. The attitude data sensor may be configured to measure a real-time attitude of the work machine. The vehicle control unit may modify the operating parameter of the work machine in response to the predictive load based on the predictive rate of change of the attitude of the work machine. The predictive rate of change of the attitude may be calculated from a ground speed and an angular change of the upcoming travel path.

The sensor processing unit further comprises an edge detection unit. The edge detection unit may identify discontinuities in either the pixel color and pixel intensity of the image data to identify edges of the upcoming terrain or the travel path.

An operating parameter of the work machine may comprise a resistance to movement of a steering wheel in response to the travel path.

An operating parameter of the work machine may also comprise an engine speed, a transmission ration, a hydraulic flow rate, a hydraulic pressure, a rimpull ratio, or a valve position.

An operating parameter of the work machine may also comprise a retarder configured to apply a braking force to either the engine, the transmission, or the drive shaft.

These and other features will become apparent from the following detailed description and accompanying drawings, wherein various features are shown and described by way of illustration. The present disclosure is capable of other and different configurations and its several details are capable of modification in various other respects, all without departing from the scope of the present disclosure. Accordingly, the detailed description and accompanying drawings are to be regarded as illustrative in nature and not as restrictive or limiting.

### BRIEF DESCRIPTION OF THE DRAWINGS

FIG. 1 is a perspective view of an example work machine in the form of an articulated dump truck in which the disclosed sensor-augmented guidance system may be used;

FIG. 2 is a dataflow diagram illustrating an example sensor-augmented guidance system in accordance with various embodiments;

FIG. 3 is a schematic illustrating a field of view of image data from the sensor in accordance with one embodiment;

FIG. 4 is a schematic illustrating a field of view of the sensor demonstrating a shift in the travel path.

FIG. 5 is a simplified block diagram showing the sensor-augmented guidance system wherein communication may occur wirelessly.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

As used herein, the term unit refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g. memory elements, digital processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the articulated dump truck described herein is merely one exemplary embodiment of the present disclosure.

For the sake of brevity, conventional techniques related to signal processing, data transmission, signaling, control, and other functional aspects of the systems and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The following describes one or more example implementations of the disclosed sensor-augmented guidance system for optimizing the operating parameters of a work machine by modifying the operating parameters and/or work machine movement based on image data received from the sensor, as shown in the accompanying figures of the drawings described briefly above. Generally, the disclosed control systems (and work vehicles in which they are implemented) provide for improved operating parameters by reducing damage to drivetrain components and reducing fuel waste by anticipating a predictive load on the work machine based on image data of the upcoming terrain or travel path, thereby protecting the work machine and its components from an overrun condition. Although the disclosed control systems are described as applied to an articulated dump truck (ADT) 14, several other work machines may use such systems. These include, but are not limited to, dump trucks, feller bunchers, tractors, loaders, trucks with a payload, to name a few.

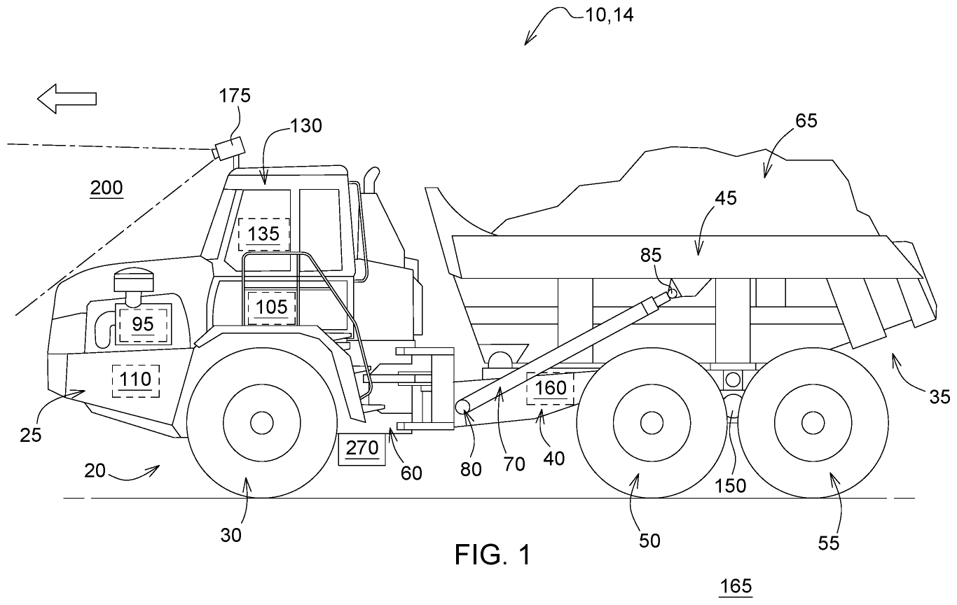

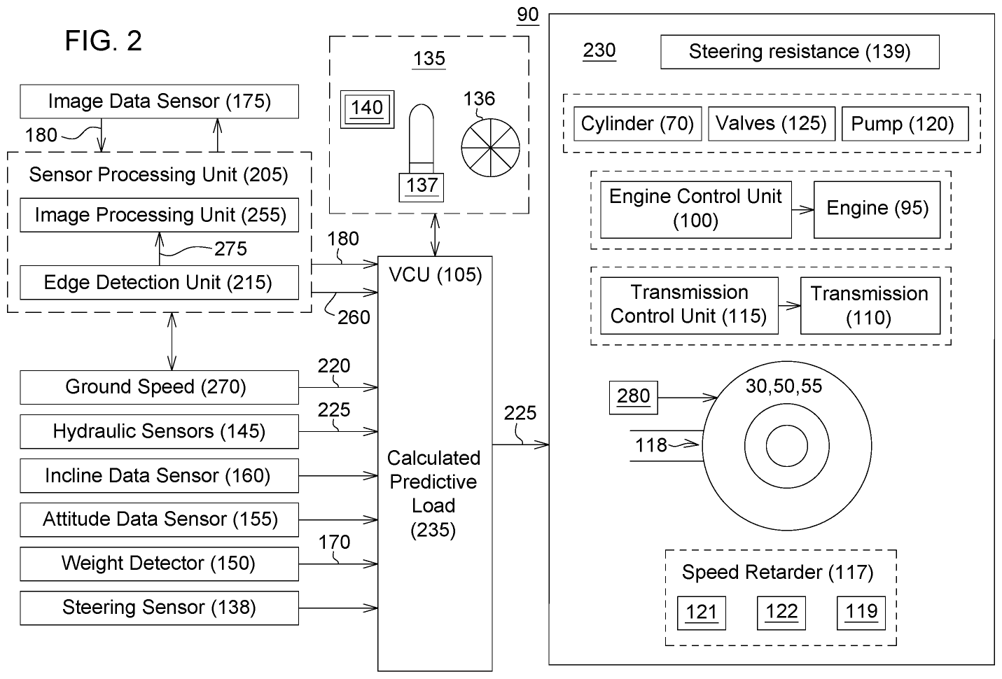

With reference to the embodiment in FIG. 1 and the diagram in FIG. 2, the work machine 10, includes a front portion 20 including a front frame 25, a front wheel assembly 30 operably coupled to the front frame 25 to support the front portion 20 and a trailer portion 35 including a rear frame 40 and a bin 45 supported by the rear frame 40. A first rear wheel assembly 50 and a second rear wheel assembly 55 are operably coupled to the rear frame 40 to support the trailer portion 35. A frame coupling 60 is positioned between the front frame 25 and the rear frame 40, the frame coupling 60 being configured to provide pivoting movement between the front frame 25 and the rear frame 40. The bin 45 is configured to support a payload 65. The bin 45 includes one or more walls which cooperate to define a receptacle to receive a payload 65. The bin 45 is generally rated to receive a certain amount of payload 65 (i.e. a rated payload capacity). Loading the receptacle of the bin 45 to a percentage of its capacity and the type of material loaded affects the load condition for the bin 45, and subsequently the work machine 10.

One or more hydraulic cylinders 70 are mounted to the rear frame 40 and to the bin 45, such that hydraulic cylinders 70 may be driven or actuated to pivot the bin 45 about coupling pins (80, 85). Generally, the work machine 10 includes two hydraulic cylinders 70, one on a left side of the bin 45 and one on a right side of the bin 45. It should be noted, however, that the work machine 10 may have any number of hydraulic cylinders, such as one, three, etc. Each of the hydraulic cylinders 70 includes an end mounted to the rear frame 40 at a pin 80 and an end mounted to the bin 45 at a pin 85. Upon activation of the hydraulic cylinders 70, the bin 45 may be moved from a lowered, loaded position to a raised, unloaded position to dump a payload 65 contained within the bin 45. It should be noted that the “loaded position” is generally a position in which the work machine 10 may carry a payload 65, for transport for example, and the “unloaded position” is generally a position in which the work machine 10 may dump a payload 65 or unload the payload 65 at a work site.

Thus, in the embodiment depicted, the bin 45 is pivotable vertically relative to a horizontal axis by the one or more hydraulic cylinders 70. In other configurations, other movements of bin 45 in alternate directions may be possible for weight stabilization. Further, in some embodiments, a different number or configurations of hydraulic cylinders 70 or other actuators may be used. In another embodiment, such as an ejector bin dump truck (not shown), hydraulic cylinders 70 may be positioned inside the receptacle of the bin 45 wherein the hydraulic cylinders 70 move a wall within the receptacle or a wall forming a portion of the receptacle to unload a payload 65 by pushing the payload out of the bin 45 as opposed to pivoting vertically relative to a horizontal axis. It will be understood that the configuration of the work machine 10 is presented as an example only.

The work machine 10 includes a source of propulsion, such as an engine 95. The engine 95 supplies power to a transmission 110. In one example, the engine is an internal combustion engine, such as the diesel engine, that is controlled by an engine control unit 100. As will be discussed herein, the engine control unit 100 receives one or more control signals or control commands from a vehicle control unit 105 to adjust a power output of the engine 95. It should be noted that the use of an internal combustion engine is merely an example, as the propulsion device can be a fuel cell, an electric motor, a hybrid-gas electric motor, etc., which is responsive to one or more control signals form the vehicle control unit 40 to reduce a power output by the propulsion device.

The transmission 110 transfers the power from the engine 95 to a suitable drivetrain coupled to one more driven wheel assemblies (30, 50, 55) of the work machine 10 to enable the work machine to move. As is known to one skilled in the art, the transmission 110 can include a suitable gear transmission, which can be operated in a variety of ranges containing one or more gears, including but not limited to a park range, a neutral range, a reverse range, a drive range, a low range, etc. A current range of the transmission 110 may be provided by a transmission control unit 115 in communication with the vehicle control unit 105, or may be provided by a sensor that observes a range shifter or range selection unit associated with the transmission 110, as known to one of skill in the art. As will be discussed, the vehicle control unit 105 may output one or more control signals or control commands to the transmission 110 or transmission control unit 115 to limit the ranges available for the operation of the transmission 110.

The work machine 10 may further include one or more speed retarders 117 configured to apply a slowing or braking force to at least one the engine 95, the transmission 110, or the drive shaft 118. A transmission retarder 119 is configured to slow the rotational speed of the transmission 110 and other drivetrain components (such as the drive shaft 118) under certain operating conditions. The transmission retarder 119 may be a hydraulic or hydrodynamic retarder, although other types of retarders may be used. In one embodiment (not shown), the transmission retarder 119 includes a plurality of vanes coupled to a shaft of the transmission and contained within a chamber of transmission retarder. Oil or other suitable fluid is introduced into the chamber of transmission retarder and may interact with the moving vanes to absorb the energy of the drive shaft and to slow the work machine or maintain a steady speed as the machine travels down an incline.

A few more examples of a speed retarder 117 include an exhaust brake and/or an engine brake (collectively referred to as engine retarder 121) to facilitate speed reduction of a work machine 10. For example, an exhaust brake may be mounted in the exhaust of a work machine for restricting airflow and slowing the engine. An engine brake may include an engine valve brake configured to increase compression in the engine 95 to slow the engine. In another embodiment, an electromagnetic retarder may be coupled to a drive shaft 118 to reduce the speed of the engine 95 and transmission 110 (referred to as a driveshaft retarder 122). The vehicle control unit 105 is communicatively coupled to and configured to adjust the strength of one or more speed retarders 117 during a modulation or shift of transmission based on the load condition and inclination of the work machine 10. This improves the shift quality of transmission 110 by providing an input into the transmission control unit 115 configured to facilitate a smoother downhill descent of the work machine as the transmission shifts between gears. As will be discussed below with respect to the sensor-augmented guidance system 90, utilizing a predictive load 235 and the image data 180 from the sensor 175, the vehicle control unit 105 may adjust the strength of speed retarders 117 prior to or during and upshift of downshift of the transmission 110.

The work machine 10 also includes one or more pumps 120, which may be driven by the engine 95 of the work machine 10. Flow from the pumps 120 may be routed through various control valves 125 and various conduits (e.g. flexible hoses) to drive the hydraulic cylinders 70. Flow from the pumps 120 may also power various other components of the work machine 10, aside from mere movement of bin 45 relative to the rear frame 40 of the work machine 10. The flow from the pumps 120 may be controlled in various ways (e.g. through control of the various controls valves 125), to cause movement of the hydraulic cylinders 70, controlling the steering of the ADT, driving a cooling/lubrication system for the transmission 110, engaging speed retarders 117 or hydraulically actuating brakes, e.g.

Generally, a vehicle control unit 105 (or multiple control units) may be provided, for control of various aspects of the operation of the work machine 10, in general. The vehicle control unit 105 (or others) may be configured as a computing device with associated processor devices and memory architectures, as a hard-wired computing circuit (or circuits), as a program-mable circuit, as a hydraulic, electrical or electro-hydraulic controller, or otherwise. As such, the vehicle control unit 105 may be configured to execute various computational and control functionality with respect to the work machine 10 (or other machinery). In some embodiments, the vehicle control unit 40 may be configured to receive input signals in various formats (e.g., as hydraulic signals, voltage signals, current signals, and so on), and to output command signals in various formats (e.g., as hydraulic signals, voltage signals, current signals, mechanical movements, and so on). In some embodiments, the vehicle control unit 105 (or a portion thereof) may be configured as an assembly of hydraulic components (e.g., valves, flow lines, pistons, cylinders, and so on), such that control of various devices (e.g., pumps or motors) may be affected with, and based on, hydraulic, mechanical, or other signals and movements.

The vehicle control unit 105 may be in electronic, hydraulic, mechanical, or other communication with various other systems or devices of the work machine 10 (or other machinery or remote systems). For example, the vehicle control unit 105 may be in electronic or hydraulic communication with various actuators, sensors, and other devices within (or outside of) the work machine 10, including various devices associated with the pumps 120, control valves 125, and so on. The vehicle control unit 105 may communicate with other systems or devices (including other controllers) in various known ways, including via a CAN bus (not shown) of the work machine 10, via wireless or hydraulic communication means, or otherwise. An example location for the vehicle control unit 105 is depicted in FIG. 1. It will be understood, however, that other locations are possible including other locations on the ADT 10, or various remote locations.

In some embodiments, the vehicle control unit 105 may be configured to receive input commands and to interface with an operator via a human-machine interface 135, which may be disposed inside a cab 130 of the work machine 10 for easy access by the operator. The human-machine interface 135 may be configured in a variety of ways. In some embodiments, the human-machine interface 135 may include one or more joysticks 137, various switches or levers, one or more buttons, a touchscreen interface that may be overlaid on a display 140, a keyboard, a speaker, a microphone associated with a speech recognition system, a steering wheel 136, or various other human-machine interface devices.

With continued reference to FIG. 2 as it relates to FIG. 1, the dataflow diagram illustrates various embodiments of a sensor-augment control system 90 for optimizing the operating parameters 230 of a work machine 10, which may be embedded within the vehicle control unit 105. Various embodiments of the sensor-augmented guidance system 90 according to the present disclosure can include any number of sub-units embedded within the vehicle control unit 105. It should be appreciated that the sensor-augmented guidance system 90 may correspond to an existing vehicle control unit 105 of the work machine 10 or may correspond to a separate processing device. For instance, in one embodiment, the vehicle control unit 105 may form all or part of a separate plug-in unit that may be installed within the work machine 10 to allow for the disclosed system and apparatus to be implemented without requiring additional software to be uploaded onto existing control devices of the work machine.

Various sensors may also be provided to observe various conditions associated with the work machine 10. In some embodiments, hydraulic sensors 145 (e.g., pressure, flow, or other sensors) may be disposed near the pumps 120 and control valves 125, or elsewhere on the work machine 10. For example, hydraulic sensors 145 may include one or more pressure sensors that observe a pressure within the hydraulic circuit, such as a pressure associated with at least one of the one or more hydraulic cylinders 70. The hydraulic sensors 145 may also observe a pressure associated with the pumps 120. The hydraulic sensors 145 may comprise weight detectors 150 that may be disposed on or coupled near the bin 45 to measure parameters including the payload 65 supported by the bin 45.

With respect to weight detectors 150, in some embodiments, the weight detectors 150 may include onboard weight (OBW) sensors, etc. In addition, the weight detectors 150 may be coupled to various locations on the work machine 10, such as one or more struts (not shown) of the work machine 10, to measure a load of the work machine 10. Thus, the weight detectors 150 observe a payload 65 of the work machine 10, which may be indicative of the load in the bin 45 or the load of the work machine 10, from which the payload 65 of the bin 45 may be extracted based on a known load of an empty work machine 10.

Other sensors may also be disposed on or near the rear frame 40 to measure parameters, such as an incline or slope of the rear frame 40, and so on. In some embodiments, the sensors may include an incline data sensor or inclination data sensor 160 coupled to or near the rear frame 40 to measure a real-time inclination of the work machine 10. In certain embodiments, the sensor may be an inertial movement unit sensors (IMU) that observe a force of gravity and an acceleration associated with the work machine. In addition, attitude data sensors 155 may be disposed near the rear frame 40 to observe an orientation of the work machine 10 relative to the direction of travel. In some embodiments, the attitude data sensors 155 include angular position sensors coupled between the rear frame 40 and the bin 45 to detect the angular orientation of the rear frame 40 relative to the ground surface 165.

For example, when the work machine 10 is positioned on a slope, the payload 65 detected at rear wheel assemblies (50, 55) may not be representative of the actual payload 65. With the work machine 10 positioned down a slope with the front wheel assembly 30 lower than the rear wheel assemblies (50,55), the work machine may experience a weight transfer toward the front of the work machine, and the detected payload weight may be less than the actual payload weight. Similarly, with the work machine positioned up a slope with the front wheel assembly 30 higher than the rear wheel assembly (50,55), the work machine 10 may experience a weight transfer toward the back of the work machine, and the detected payload weight may be more than the actual payload weight. To reduce the likelihood of a weight calculation error, the vehicle control unit 105 is configured to adjust the detected payload weight based on the detected slope or inclination angle. For example, the vehicle control unit 105 may calculate the actual payload weight (may also be referred to hereinafter as measured weight 170) based on the weight detected at rear wheel assemblies (50,55) with weight detectors 150 and the ground slope angle detected with an inclination data sensor 160.

The work machine 10 also comprises steering inputs as part of the human-machine interface 135 such as a steering wheel 136 or joystick 137. To turn the work machine 10 to the right, the operator rotates the steering wheel 136 in a clockwise direction or moves the joystick 137 in a right direction. Similarly, to turn the work machine to the left, the operator rotates the steering wheel 136 in a counterclockwise direction or moves the joystick 137 in a left direction. The vehicle control unit 105 receives signals from a steering sensor 138 positioned to detect movement of the steering wheel 136 or joystick 137. Based on these signals, the vehicle control unit 105 instructs fluid control provide hydraulic cylinders 70 with the appropriate rate and direction of flow to turn the work machine 10 to the right or to the left. The vehicle control unit 105 provides gain or a relationship between the number of turns of the steering wheel 136 required to turn the work machine 10. This gain, also known as steering resistance 139, may be adjusted by the vehicle control unit 105 based on the speed of the work machine 10 and the measured weight 170 from the weight detector 150 which is variable based on the payload 65. For example, when working at slow speeds, fewer turns of the steering wheel 136 are required to turn a certain angle. When operating in relatively tight conditions such as a quarry, the vehicle control unit 105 may provide a relatively higher gain, or greater sensitivity to wheel turns. Alternatively, when the work machine 10 is on the road and traveling at high speeds, the vehicle control unit 105 may provide a lower gain requiring more turns to turn a certain angle. Detection of the ground speed 270 and measured weight 170 in conjunction with the predictive load 235, to be discussed in detail below, based on the upcoming terrain 185 and the upcoming travel 190 path will be inputs for modifying an operating parameter 230 such as the steering resistance 139. Anticipating large changes in gradient and upcoming sharp turns in the travel path 190 may impact the steering resistance 139 to advantageously prevent the work machine 10 from tipping over.

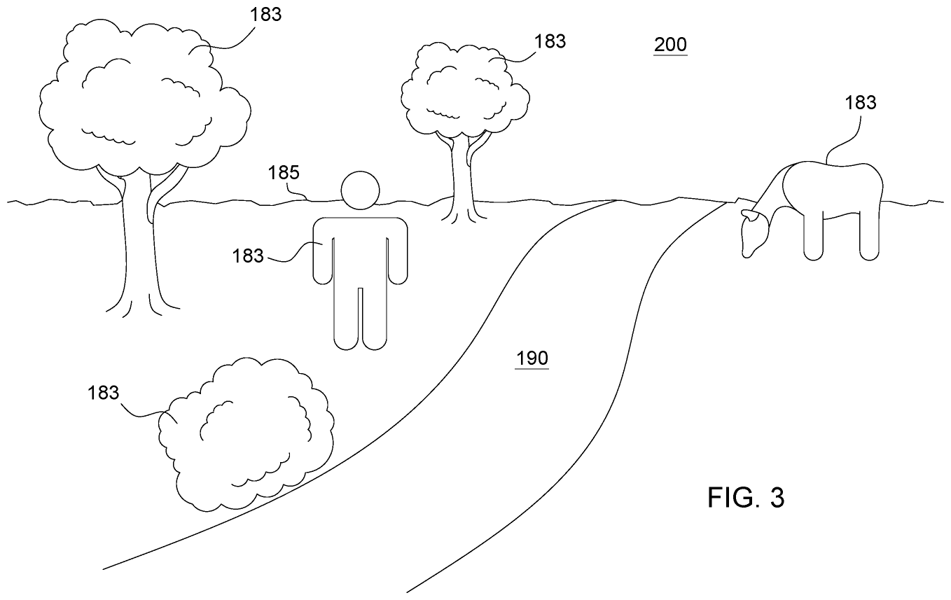

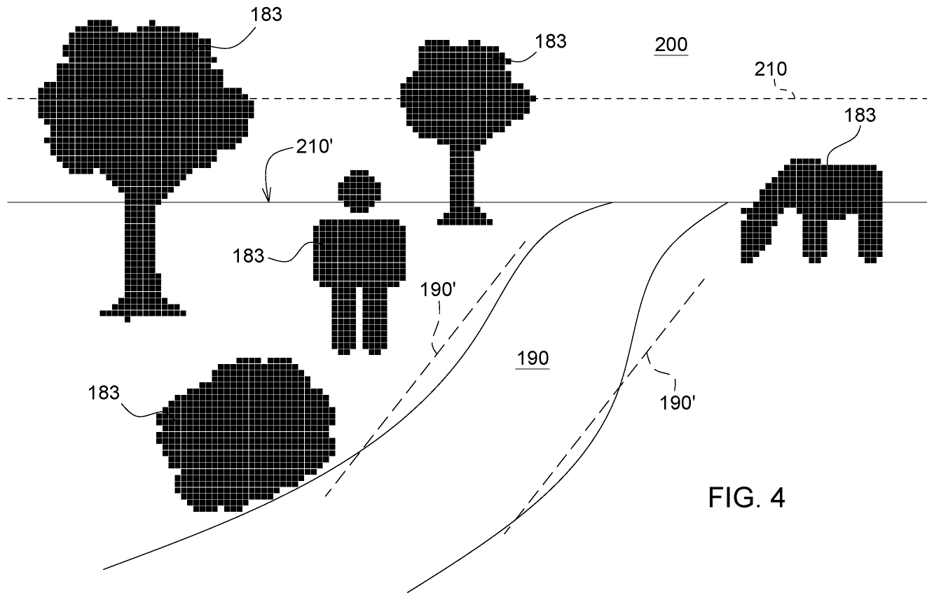

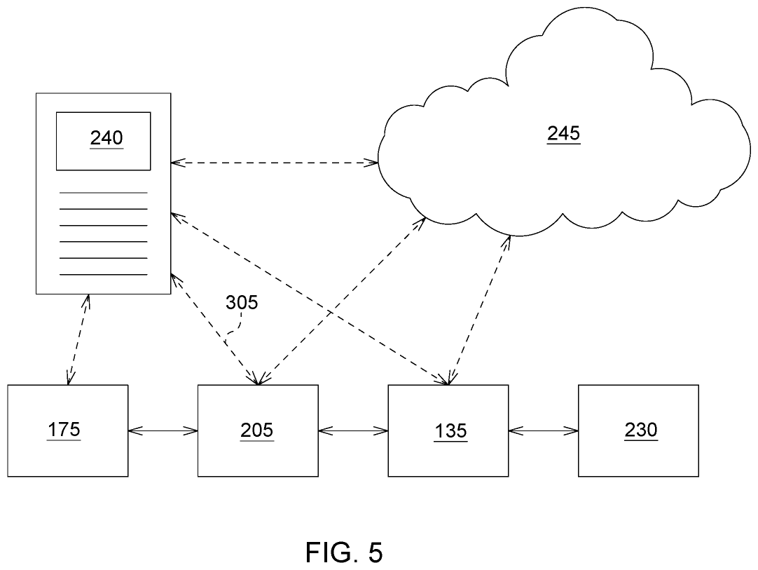

Now turning to other aspects of the feed forward guidance aspect in the sensor-augmented guidance system 90. The work machine 10 comprises a sensor 175 facing in a generally forward direction (as indicated by the arrow in FIG. 1). The forward direction may be either parallel to the fore-aft direction of the work machine 10, or in a generally forward direction wherein the sensor may move and face in a direction anywhere in an area forward of the work machine 10. The sensor 175 is configured to collect image data 180 (depicted in the diagram of FIG. 2 and shown in FIGS. 3 and 4) of either the upcoming terrain 185 or the travel path 190 in the field of view 200 of the sensor 175. Any sensing device capable of collecting image data 180 may be used. For example, a stereoscopic camera may capture image data 180 of the field of view 200 or features within a field of view 200, and a sensor processing unit 205 may analyze such image data 180 to determine the presence of a slope or an obstacle. The sensor processing unit 205 which is communicatively coupled to the sensor 60 is also configured to receive the image data 180 from the sensor 175, and identify either upcoming terrain 185 and/or an upcoming travel path 190 based on the image data 180. The sensor processing unit 205 or any other control unit as described below, may be located on the work machine 10, on the sensor 175, as part of the vehicle control unit 105, a mobile device 240, or another location such as a cloud 245 wherein communication occurs through a wireless data communication device 250 (e.g. Bluetooth shown in dotted lines as shown in FIG. 5).

Now turning to FIGS. 3, 4A, and 4B with continued reference to FIG. 2, The sensor processing unit 205 may comprise an edge detection unit 215 and/or image processing unit 255 communicatively coupled to sensor 175. The edge detection unit 215 identifies discontinuities in either pixel color or pixel intensity of the image data 180 to identify edges. The sensor processing unit 205 may identify objects 183 and horizon 210 in the upcoming terrain 185 and or the travel path 190 based on the discontinuities. The edge detection unit 215 may apply an edge detection algorithm to image data 180. Any number of suitable edge detection algorithms can be used by the edge detection unit 265. Edge detection refers to the process of identifying and locating discontinuities in pixels in an image data 180 or collected image data. Note that pixels are represented by the square block aggregates shown in FIG. 4. For example, the discontinuities may represent material changes in pixel intensity or pixel color which define the boundaries of objects in an image. A gradient technique of edge detection may be implemented by filtering image data to return different pixel values in first regions of greater discontinuities or gradients than in second regions with lesser discontinuities or gradients. For example, the gradient technique detects the edges of an object 183 by estimating the maximum and the minimum of the first derivative of the pixel intensity of the image data. The Laplacian technique detects the edges of an object in an image by searching for zero crossings in the second derivative of the pixel intensity image. Further examples of suitable edge detection algorithms include, but are not limited to, Roberts, Sobel, and Canny, as are known to those of ordinary skill in the art. The edge detection unit 215 may provide a numerical output, signal output, or symbol indicative, of the strength or reliability of the edges in field. For example, the edge detection unit 215 may provide a numerical value or edge strength indicator within a range or scale or relative strength or reliability to the linear Hough transformer.

The linear Hough transformer receives edge data 275 (e.g. an edge strength indicator) related to the upcoming terrain 185, objects 183, and travel path 190, and identifies the estimated angle and offset of the strong line segments, curved segments or generally linear edges in the image data 180. The linear Hough transformer comprises a feature extractor for identifying line segments of objects with certain shapes from the image data 180. For example, the linear Hough transformer identifies the line equation parameters or ellipse equation parameters of objects in the image data 180 from the edge data 275 outputted by the edge detector, or Hough transformer classifies the edge data 275 as a line segment, an ellipse, or a circle. Thus, it is possible to detect the sub-components such large boulders, divots in the ground, trees, persons, signs, lane marking, or man-made materials such as pipes, each of which may have generally linear, rectangular, elliptical or circular features. Alternatively, the edge detection unit 100 may simply identifying an estimated outline of objects.

The edge detection unit may also identify an upcoming slope for example by tracking movement of an identified horizon 210 (i.e. where the sky meets the earth) using the edge detection unit 215 of the sensor processing unit 205, and measure a change in the horizon 210 in conjunction with the ground speed 270, gradient from the incline data sensor 160, measured weight 170 from the weight detector 170 and attitude from the attitude data sensor 155 of the work machine 10 to identify upcoming terrain 185 and/or the upcoming travel path 190 and calculate a predictive load 235. The sensor 175 (also may be referred to hereinafter as the image data sensor) may operate in the visible spectrum. Devices such as infrared cameras, cameras which utilize movement of the work machine to improve image recognition, RADAR systems, and scanning LIDAR systems may also be used to recognize gradients and/or obstacles. Having recognized a gradient, an obstacle, or the severity of the slope or obstacle and calculating the approximate time when such a gradient or obstacle will be encountered, the vehicle control unit 105 may select to modify one of several operating parameters 230 (shown in FIG. 2) to said severity of the upcoming terrain 185 and/or travel path 190, with a calculated predictive load 235 based on the measured weight 170 from weight detector 150 and whether the work machine 10 will be traversing uphill, downhill, curving left, or curving right. The image data capturing sensor 175 may be looking in the direction of the intended travel path 190, positioned somewhere on or near the front frame 25 of the work machine 10. While a fixed sensor may be sufficient in a case, where the upcoming terrain and travel path are easy to see and to measure under all or most circumstances, a moveable sensor may orient itself or may get oriented by an operator such that the visibility of the upcoming terrain 185 or travel path 190 in a field of view 200 is optimized. The sensor processing unit 205, communicatively coupled to the sensor 175, is configured to change the resolution, focal length, or zoom of the sensor 175 based on the ground speed 270 of the work machine 10, wherein the speed signals 220 may be received from the vehicle control unit 105 as it receives the speed signals 220 from a ground speed sensor. Adjustments to the image data capturing sensor 175 may be made to look farther ahead, narrow the field of view to focus on objects in the distance, or alter the resolution of the image to recognize objects further away. In one aspect, the image data capturing sensor 175 may zoom out farther from the work machine 10 as the work machine's speed increases. In another aspect, the image data capturing sensor 175 may increase its image resolution so that objects 183 that are further away have enough pixel density to classify and recognize objects with specificity. Low resolution images may have large block-like pixels that do not provide enough distinct shapes to recognize large boulders, divots in the ground, trees, persons, signs, or other obstacles found in upcoming terrain 185 or travel path 190. The field of view 200 of the sensor 180 may be tilted downwards from a generally horizontal plane at a down-tilted angle (e.g. approximately 5 to 30 degrees from the horizontal plane or horizontal axis). This advantageously provides relatively less sky in the field of view 200 of the image data capturing sensor 175 such that the collected image data 180 tends to have a more uniform image profile. The tilted configuration is also well suited for mitigating the potential dynamic range issues of bright sunlight or intermediate cloud cover, for instance. Additionally, tilting the sensor 175 downwards may reduce the accumulation of dust and other debris on the external surface of the sensor 175. This is especially applicable for a stereoscopic vision device type device where pixels in image data 180 is collected.

Now turning to FIG. 2, as previously mentioned, the vehicle control unit 105 is communicatively coupled with the sensor processing unit 205 and the weight detector 150, wherein the vehicle control unit 105 is configured to modify an operating parameter 230 of the vehicle control unit 105 in response to at least one of a predictive load 235 based on the measured weight 170, and at least one of the upcoming terrain 185 and the upcoming travel path 190. The vehicle control unit 105 outputs the one or more control signals 225 or control commands to the pumps 120 and/or control valves 125 associated with hydraulic cylinders 70 to modify a speed of the hydraulic cylinders 70 based on the predictive load 235 calculated from one or more of the signals received from the sensors 145, 150, 155, 160, 270, 138, and 175, and input received from the human-machine interface 135. In some embodiments, the vehicle control unit 105 outputs the one or more control signals 225 or control commands to modify a flow rate of the hydraulic fluid to the pumps 120 and/or control valves 125. For example, reduction in the flow rate slows or reduces the speed of the hydraulic cylinders 70. As previously mentioned, modification of a flow rate of the hydraulic fluid to the pumps 120 and/or control valves 125 may also be used to modify operating parameters 230 such as controlling the steering resistance 139, driving a cooling/lubrication system for the transmission 110, or hydraulically actuating brakes.

The vehicle control unit 105 also outputs one or more control signals 225 or control commands to the engine control unit 100 to modify a speed of the engine 95 based on the predictive load 235 calculated from one or more of the sensor signals received from the sensors 145, 150, 155, 160, 270, 138, and 175, and input received from the human-machine interface 135. The vehicle control unit 105 may further output one or more control signals 225 or control commands to the transmission control unit 115 to reduce the number of ranges available for the transmission 110 based on one or more of the sensor signals received from the sensors 145, 150, 155, 160, 270, 138, and 175, and input received from the human-machine interface 135. The reduction in the number of ranges available slows or reduces the speed of the work machine 10. On the contrary, increasing the number of ranges available increases the speed of the work machine 10. Additionally, other operating parameters 230 affected may be a speed retarder 117, driveshaft 118 (or other drivetrain components), and rimpull 280.

Returning to FIGS. 3, 4A and 4B with continued reference to FIG. 2, the sensor processing unit 205, as previously mentioned, may comprise an image processing unit 255 and an edge detection unit 265. In one embodiment, the image processing unit 255 may calculate the spatial offset 260 of the upcoming terrain 185 and/or travel path 190 from the image data 180 from the sensor 175. The image processing unit 255 may applies a stereo matching algorithm or disparity calculator to the collected image data 180 if the sensor 175 is a stereoscopic vision device. The stereo matching algorithm or disparity calculator determines the disparity for each set of corresponding pixels in the right and the left image and then estimates a spatial offset 260 of the sensor 175 from objects 183 in the upcoming terrain 185, using this measured distance, the known distance between the right and the left lens of the sensor 175, and the ground speed 270.

Alternatively, or in conjunction with the above, the image processing unit 255 may identify a set of two-dimensional or three-dimensional points (e.g. Cartesian coordinates or Polar coordinates) in the collected image data 180 that define a shrub, an aggregate of points defining shrubs, or both. The set of two-dimensional or three-dimensional points may correspond to pixel positions in images collected by the sensor 175 (for a non-stereoscopic device image analysis). The image processing unit 255 may rectify the image data 180 to optimize analysis. The image processing unit 255 may use color discrimination, intensity discrimination, or texture discrimination to identify pixels from one or more object pixels from the image data 62 and associate them with pixel patterns, pixel attributes (e.g. color or color patterns like Red Green Blue (RGB) pixel values), pixel intensity patterns, texture patterns, luminosity, brightness, hue, or reflectivity to identify the upcoming terrain 185 (examples of which were previously discussed) and the travel path 190, and the spatial offset 260 from the sensor 175 with a calculated or measured spatial offset 260 of the object, upcoming ascending travel path or descending travel path from the sensor 175 based on a change in the horizon 210 (designated by the dotted line 210′ and solid horizontal line 210 in FIG. 4 as an example), movement of objects 183, turns to either the left of the right in the upcoming travel path 190 and the degree/sharpness of the turn (designated by lines 190′). The predictive load 235 is calculated based on this image data 180, as well as data possibly received from sensors 145, 150, 155, 160, 270, and 138. That is, the sensor-augmented guidance system 90 may further comprise an inclination data sensor 160 communicatively coupled to the vehicle control unit 105 wherein the inclination data sensor 160 is configured to measure a real-time inclination of the work machine 10. The vehicle control unit may modify an operating parameter 230 of the work machine in response to the predictive load 235 based on a predictive rate of change of the inclination and the measured weight 170 of the payload 65. The predictive rate of change of the inclination may be calculated from a ground speed 270 and a rate of change of a moving horizon 210 from the image data 180.

One or more of the steps or operations in any of the processes, or systems discussed herein may be omitted, repeated, or re-ordered and are within the scope of the present disclosure.

While the above describes example embodiments of the present disclosure, these descriptions should not be viewed in a restrictive or limiting sense. Rather, there are several variations and modifications which may be made without departing from the scope of the appended claims.

What is claimed is:

1. A sensor-augmented guidance system for optimizing an operating parameter of a work machine, the work machine comprising a front portion including a front frame, a front wheel assembly operably coupled to the front frame to support the front portion, a trailer portion including a rear frame and a bin supported by the rear frame, the bin configured to support a payload, a first and second rear wheel assemblies operably coupled to the rear frame to support the trailer portion; a frame coupling positioned between the front frame and the rear frame, the frame coupling being configured to provide pivoting movement between the front frame and the rear frame; the system comprising:
a sensor coupled to the front frame of the work machine, the sensor facing in a forward direction, the sensor configured to collect image data in a field of view of the sensor;
a sensor processing unit communicatively coupled with the sensor, the sensor processing unit configured to receive the image data from the sensor, and identify at least one of an upcoming terrain and an upcoming travel path based on the image data;
a weight detector coupled to the rear frame of the work machine to calculate a measured weight of the payload supported by the bin; and
a vehicle control unit communicatively coupled with the sensor processing unit and the weight detector, the vehicle control unit configured to modify the operating parameter of the work machine in response to a predictive load based on the measured weight, and at least one of the upcoming terrain and the upcoming travel path.

2. The system of claim 1 further comprising an inclination data sensor communicatively coupled to the vehicle control unit, the inclination data sensor configured to measure a real-time inclination of the work machine, wherein the vehicle control unit modifies the operating parameter of the work machine in response to the predictive load based on a predictive rate of change of an inclination.

3. The system of claim 2, wherein the predictive rate of change of the inclination is calculated from a ground speed and a rate of change of a moving horizon from the image data.

4. The system of claim 2, wherein the predictive rate of change of the inclination is based on a moving average of the real-time inclination over a measured distance.

5. The system of claim 1 further comprising an attitude data sensor communicatively coupled to the vehicle control unit, the attitude data sensor configured to measure a real-time attitude of the work machine, wherein the vehicle control unit modifies the operating parameter of the work machine in response to the predictive load based on a predictive rate of change of the attitude of the work machine.

6. The system of claim 5, wherein the predictive rate of change of the attitude is calculated from a ground speed and an angular change of the upcoming travel path.

7. The system of claim 1, wherein the sensor processing unit further comprises an edge detection unit, the edge detection unit identifying discontinuities in at least one of pixel color and pixel intensity of the image data to identify edges, the edge detection unit identifying edges of at least one of the upcoming terrain and the travel path.

8. The system of claim 1, wherein the operating parameter of the work machine comprises a resistance to movement of a steering wheel in response to the upcoming travel path.

9. The system of claim 1, wherein the operating parameter of the work machine comprises at least one of an engine speed, a transmission ratio, a hydraulic flow rate, a hydraulic pressure, a rimpull ratio, and a valve position.

10. The system of claim 1, wherein the operating parameter of the work machine comprises a retarder configured to apply a braking force to at least one of an engine, a transmission, and a drive shaft.

11. A work machine having a sensor-augmented guidance system for optimizing an operating parameter of the work machine, the work machine comprising:
a front portion including a front frame;
a front wheel assembly operably coupled to the front frame to support the front portion;
a trailer portion including a rear frame and a bin supported by the rear frame, the bin configured to support a payload;
a first and second rear wheel assemblies operably coupled to the rear frame to support the trailer portion;
a frame coupling positioned between the front frame and the rear frame, the frame coupling being configured to provide pivoting movement between the front frame and the rear frame;
a sensor coupled to the front frame of the work machine, the sensor facing in a forward direction, the sensor configured to collect image data in a field of view of the sensor;
a sensor processing unit communicatively coupled with the sensor, the sensor processing unit configured to receive the image data from the sensor, and identify at least one of an upcoming terrain and an upcoming travel path based on the image data;
a weight detector coupled to the rear frame of the work machine to calculate a measured weight of the payload supported by the bin; and
a vehicle control unit communicatively coupled with the sensor processing unit and the weight detector, the vehicle control unit configured to modify the operating parameter of the work machine in response to a predictive load based on the measured weight, and at least one of the upcoming terrain and the upcoming travel path.

12. The work machine of claim 11 further comprising an inclination data sensor communicatively coupled to the vehicle control unit, the inclination data sensor configured to measure a real-time inclination of the work machine, wherein the vehicle control unit modifies the operating parameter of the work machine in response to the predictive load based on a predictive rate of change of the inclination.

13. The work machine of claim 12, wherein the predictive rate of change of the inclination is calculated from a ground speed and a rate of change of a moving horizon from the image data.

14. The work machine of claim 12, wherein the predictive rate of change of the inclination is based on a moving average of a real-time inclination over a measured distance.

15. The work machine of claim 11 further comprising an attitude data sensor communicatively coupled to the vehicle control unit, the attitude data sensor configured to measure a real-time attitude of the work machine, wherein the vehicle control unit modifies the operating parameter of the work machine in response to the predictive load based on a predictive rate of change of the attitude of the work machine.

16. The work machine of claim 15, wherein the predictive rate of change of the attitude is calculated from a ground speed and an angular change of the upcoming travel path.

17. The work machine of claim 11, wherein the sensor processing unit further comprises an edge detection unit, the edge detection unit identifying discontinuities in at least one of pixel color and pixel intensity of the image data to identify edges, the edge detection unit identifying edges of at least one of the upcoming terrain and the travel path.

18. The work machine of claim 11, wherein the operating parameter of the work machine comprises a resistance to movement of a steering wheel in response to the upcoming travel path.

19. The work machine of claim 11, wherein the operating parameter of the work machine comprises at least one of an engine speed, a transmission ratio, a hydraulic flow rate, a hydraulic pressure, a rimpull, and a valve position.

20. The work machine of claim 11, wherein the operating parameter of the work machine comprises a speed retarder configured to apply a braking force to at least one of an engine, a transmission, and a drive shaft.
